(19) United States
(12) Patent Application Publication
(10) Pub. No.: US 2021/0390630 A1
(43) Pub. Date: Dec. 16, 2021

(54) ELECTRONIC MARKETPLACE FOR TIME-BOUNDED MARKETPLACE EVENTS

(71) Applicant: Daniel Brooks MacDonald, Farmington, UT (US)

(72) Inventor: Daniel Brooks MacDonald, Farmington, UT (US)

(21) Appl. No.: 16/902,045

(22) Filed: Jun. 15, 2020

(51) Int. Cl. G06Q 50/00; G06Q 10/10; G06Q 30/00; G06Q 30/02; G06Q 30/06; G06F 16/906

(52) U.S. Cl. CPC G06Q 50/01; G06Q 10/101; G06F 16/906; G06Q 30/0282; G06Q 30/0625; G06Q 30/016

(57) ABSTRACT

In an electronic communication platform between a computing system and a plurality of network-based remote customers, an internet information transmission and processing system for time-bounded marketplace events. A system for publishing and querying electronic marketplace event catalogs, social networking across the platform before marketplace events, and induces collaboration of remote customers during and after marketplace events. The system includes cataloged datasets of customer data and information, digital storage media for primarily storing catalogs and webpages, and an e-marketplace gateway for primarily storing separate published catalogs and webpages while associated by a digital-relationship.

### BACKGROUND OF THE INVENTION

### 1. Field of the Invention

The present invention relates to an interactive network and method for remote customer publication and review of electronic marketplace webpages.

### 2. Description of Related Art

A critical role of the marketplace is to align customers requirements in order to create value-relationships to facilitate dialogue for a common outcome (i.e. products, services, events, discover information, support group, etc).

Typically the commercial marketplaces or community marketplaces rely heavily on generic advertisement paid by sponsors of the affair, through various traditional media (e.g. website, newspaper, magazine, radio, direct mail). This process encourages the audience to participate in such a promotion but takes little consideration for the interest of the independent merchants who have specific fulfillment needs.

The reliance of the independent merchants on this traditional media has inherent limitation for developing social exchange for a common outcome, given the “in person” nature of this type of marketplace. In this way, the interaction of customers to build relationships is merely happen-stance, providing the need to locate, evaluate and obtain products, services or other mutual correspondence that meets the current circumstance (e.g., connect with people, set up registration/contact forms, collect data, and generate “Leads”). Currently, these practices of time-bounded activities constrain customers to discover targeted information and develop relationships for common opportunities. Alternatively, web-based marketplace applications use search engines as the most common means for evaluating product offerings, and in general targets specific electronic markets by distilling gross information from independent outside sources (e.g. http://www.globalspec.com) which is typically not associated with a marketplace but rather independent suppliers. Unfortunately while using this process, the participants struggle with accurate and useful results due to language disparities of independent supplier's catalogs. On the other-hand, the typical web-based social network (e.g. Facebook.com, Linkedin.com) is constructed using an individual's profile within a bounded network assembled by acceptance of “friend” or an “interest” profile through the display of social connections. This acceptance process of expanding individual networks typically provides hyperlinks to a “virtual store”. Through this process, the development of network relationships is of little consideration and provides minimal opportunity for face-to-face social exchange.

The present invention overcomes the above drawbacks of the background arts by providing a process and configuration for marketplace participants in an electronic marketplace environment. The inventive system eliminates time bounded evaluation and decision making for customers when exploring marketplace events.

### BRIEF SUMMARY OF THE INVENTION

To address the shortcomings of the prior art, one embodiment of the present invention provides an internet communication platform between a computing system and a plurality of network-based remote customers, an internet information transmission and processing system for time-bounded marketplace events.

A system for publishing and querying electronic marketplace event catalogs, social networking across the platform before marketplace events, and induces collaboration of remote customers during and after participating in marketplace events, the system is provided, comprising cataloged datasets of customer data and information, digital storage media for storing catalogs and webpages, an e-marketplace gateway for storing separately the published catalogs and webpages tied together by an associated digital-relationship, a publish manager for creating, securing and publishing publisher customer catalogs and webpages, a inquiry manager for creating inquiry customer catalogs and querying eMarketplace publications, a marketplace manager for storing and querying publications, a publication administrator for navigating activities across the e-marketplace gateway, a registration administrator for creating and updating customer records, and a notification messenger for notifying remote customers across the network and platform.

Wherein registration administrator connects remote customers transmission across the network and platform, the publish manager induces the remote publisher customer to create electronic marketplace catalogs and webpages, and then the digital-storage media stores the remote publisher customer catalogs and webpages, where then the publication administrator induces the publish manager to release the publisher customer catalogs and webpages for an eMarketplace publication, where then the marketplace manager enables the e-marketplace gateway to create an digital-relationship for the catalogs and webpages and the digital storage media stores separately the publisher customer catalogs and webpages for secure eMarketplace publication available for query, the inquiry manager induces the remote inquiry customer to create catalogs for querying complementary e-marketplace catalogs and to present the associated webpages for review, where then the system induces complementary remote customers for interaction across the network and platform, and ultimately for face-to-face marketplace event collaboration.

Also in one embodiment the notification messenger notifies remote customers of new or updated complementary catalogs, where then system induces remote customer interaction across network and platform and ultimately for face-to-face marketplace event collaboration;

In another aspect of the invention a method enabling customers communication being descriptive of publisher P, inquiry I, is provided, comprising (1) means for interaction across network and platform for remote customer—P to I, I to P, (2) means for social interaction across network and platform for remote customers—P to a plurality of I, I to a plurality of I, (3) means for face-to-face collaboration for remote customer—P to I, I to P, (4) means for face-to-face social collaboration for remote customers—P to a plurality of I, I to a plurality of I.

The eMarketplace system provides customers an electronic network of forums that align individuals and entities with common interest for electronic interaction and ultimately face-to-face marketplace event exchange. Catalogs comprise a standard order of independent and organized datasets that targets the interests of the publisher and inquiry customers of specific marketplace events and interests. This process provides relevant relationships for social exchange for a common outcome for local open marketplace events (e.g. swap meets, farmer markets) as well as commercial conventions or trade show events (e.g. MDM, Pack Expo, SEMA, Outdoor Retailer, Comic Con).

In general, the eMarketplace catalogs describe datasets specific to the marketplace event and can be customize in accordance to the publishers urgency to update ongoing requirements. The datasets provide the targeted search opportunity that aligns the publisher and inquiry customer of common interests. The eMarketplace system provides customers to communicate across the eMarketplace network that supports a community of marketplace opportunities and ultimately interact of face-to-face collaboration.

A primary advantage of this system is that it provides an effective electronic publishing method for marketplace event participants that deliver targeted information for motivated customers. The eMarketplace system elevates constructive face-to-face social exchange and provides collaboration methods before, during and after the marketplace event that ultimately contributes to mutual and complementary actions of customers with common interest.

In one aspect, complementary actions include mutual interest for specific events (i.e. participants of: trade shows, conferences, farmer markets, swap meets, etc.), and in additional aspects through collaborative means across unlikely industries (i.e., defense technology vs. medical research) and/or developmental applications (i.e., inorganic/organic chemicals, novel/advanced polymeric materials, sustainable energy, pharmaceutical molecules, etc.) and future proprietary ideas and/or development.

The electronic system provides the visibility of marketplace event opportunities without limit of geographical or communication constraints. This result is an expanded network of knowledge across remote customers of complementary interaction and ideally of face-to-face collaboration. Furthermore, because the electronic system automatically filters relative eMarketplace information while protecting proprietary data of similar or dissimilar industries, it allows the highest quality return of information and social exchange providing an optimum customer experience.

These and other features, aspects, advantages, properties and relationships of the present invention will become better understood from the following definitions, detailed description and accompanying drawings which set forth an illustrative embodiment and which are indicative of the various ways in which the principles of the invention may be employed.

### Definitions

The term “eMarketplace” herein denotes an online electronic marketplace that primarily represents physical marketplace event attributes and allows customers to electronically participate according to the present invention.

The term “dataset” herein denotes a collection of useful unit data composed of separate element held in electronic form, describe as: terms, definitions, pictures, .gif, links, video, software, digital tokens, interrogative information and other electronic formats suitable for storing.

The term “catalog” herein denotes a stand-alone group of related datasets that can be manipulated as a unit.

The term “independent and organized” herein denotes that the electronic data from different catalogs do not depend on each other and also forms as or into a whole consisting of coordinated data that is provided for united action.

The term “publication” herein denotes eMarketplace public webpages separate from associated catalogs but tied together by a “digital-relationship”.

The term “digital storage media” herein denotes any combination of centralized local or remote databases, or decentralized blockchain networks, or other architecture and application for storing electronic data and information in accordance to the present invention.

The term “time-bounded” herein denotes ‘subject to time limits’, referring to the length of time for participating in an event, for example but not limited to: a business week e.g., trade shows, exhibitions, conferences (typically 5 days) or weekends e.g. farmers markets, swap meets, yard sales, etc.

The term “articles” herein denotes customer core competency (e.g. products, services, information, resources, etc.) that provide the capability or advantage that distinguishes them from its competitors.

### BRIEF DESCRIPTION OF THE SEVERAL VIEWS OF THE DRAWINGS

FIG. 1 illustrates a “location” catalog and dataset that addresses where a marketplace event takes place, according to one embodiment of the present invention;

FIG. 2 illustrates an “articles” catalog and dataset that addresses the core competencies of what a marketplace event offers, according to one embodiment of the present invention;

FIG. 3 is a simplified block diagram describing general architecture of a system of one embodiment of the present invention;

FIG. 4 is a flowchart illustrating a registration administrator and its method of operation according to one embodiment of the present invention;

FIG. 5 is a flowchart illustrating a publish manager and its method of operation according to one embodiment of the present invention;

FIG. 6 is a flowchart illustrating a inquiry manager and its method of operation according to one embodiment of the present invention;

FIG. 7 is a flowchart illustrating a marketplace manager and its method of operation according to one embodiment of the present invention;

FIG. 8 illustrates an electronic marketplace network diagram describing general architecture of a system according to one embodiment of the present invention.

FIG. 9 illustrates a preferred computerized and network environment for implementing a system and method according to one embodiment of the present invention.

### DETAILED DESCRIPTION OF THE INVENTION

An inventive system and method is disclosed of an electronic marketplace network for conducting the publication of marketplace event information to facilitate high-value face-to-face interaction of customers with common interests. Preferably implemented over the internet's World Wide Web, the eMarketplace system allows customers to dynamically customize webpages and cataloged datasets while securely protecting proprietary information, allows customers to publish and query e-Marketplace catalogs, provides notifications for social interaction of customers with common interests, and closes the eMarketplace event publication when the marketplace event is concluded.

The process of optimizing “interactive-engagements” during these face-to-face collaborative environments is administered by duplicating existing, or creating new web content while also including “core competency” catalogs on an eMarketplace network, ideally prior to the engagement. Core competency catalogs allow the ability to query targeted knowledge and industry trade information specific to the requirements of event participants for mutual and quicker resolution during these time bounded events.

This process ensures the greatest prospects for creating high-value leads, developing professional relationships, evaluating “proof of concept” initiatives, and aligns critical requirements amongst participants that distinguish them from competitors. In addition, the system provides notifications for social interaction of participants across the eMarketplace network for customers with common interests.

Furthermore, because catalogs target the fundamentals of individuals, business and entities, the system connects professionals of similar or dissimilar industries and/or competencies from diverse businesses, across trades, across engineering or scientific specialties, and across continents the ability to partner or provide insight for research & development, “next-generation” opportunities, best practice applications, etc.

The process for face-to-face collaboration of customers with common interests in accordance to the present invention is executed by an electronic communication platform between a computing system and a plurality of network-based remote customers encountering event opportunities in response to an electronic query of published eMarketplace event information, comprising means for publishing, querying and social exchange for marketplace event information across the networks and platform, updating means for updating eMarketplace publications, receiving means for receiving notification of complementary eMarketplace publications and catalogs, and contact means for social interacting across the network in response to eMarketplace publications.

The inventive system includes webpage builders and digital storage media that store and maintains customer information and other relevant information in a commercially available database system. Through methods of a publishing process, publisher customer creates webpages and then populates cataloged datasets on centralized database system or decentralized database networks. Webpages and catalogs best represents publisher's core competencies as well as the physical marketplace event. A publisher customer then publishes the content on the eMarketplace network making the event available for review.

Similarly through method of an inquiry process, inquiry customer populates cataloged datasets of marketplace events of their interests and queries eMarketplace publications which then presents associated webpage postings. The system allows individuals charged with maintaining relevant information into catalogs at his or her leisure.

The present invention further provides, an electronic communication platform between a computing system and a plurality of network-based remote customers, an internet information transmission and processing system for time-bounded marketplace events. A system for publishing and querying electronic marketplace event catalogs, social networking across the platform before marketplace events, and induces collaboration of remote customers during and after marketplace events, the system is provided, comprising cataloged datasets of customer data and information, digital storage media for storing catalogs and webpages, an e-marketplace gateway for storing separate published catalogs and webpages associated by digital-relationship, a publish manager for creating, securing and publishing publisher customer catalogs and webpages, a inquiry manager for creating inquiry customer catalogs and querying eMarketplace publications, a marketplace manager for storing and querying publications, a publication administrator for navigating remote customers across an e-marketplace gateway, a registration administrator for creating and updating customer records, and a notification messenger for notifying remote customers across a network and platform.

Wherein registration administrator connects remote customers transmission across a network and platform, publish manager induces remote publisher customer for create electronic marketplace catalogs and webpages, and then digital-storage media stores remote publisher customer catalogs and webpages, where then publication administrator induces publish manager release publisher customer catalogs and webpages for an eMarketplace publication, where then marketplace manager enables e-marketplace gateway create digital-relationship for associated catalogs and webpages and digital storage media stores separate publisher customer catalogs and webpages for secure eMarketplace publication available for query, inquiry manager induces remote inquiry customer for create catalogs for querying complementary e-marketplace catalogs and present associated webpages for review, where then system induces complementary remote customer interaction across a network and platform, and ultimately for face-to-face marketplace event collaboration, and notification messenger notifies remote customers of new or updated complementary catalogs, where then system induces remote customer interaction across network and platform and ultimately for face-to-face marketplace event collaboration, and enabling customers communication being descriptive of publisher P, inquiry I, is provided, comprising (1) means for interaction across network and platform for remote customer—P to I, I to P, (2) means for social interaction across network and platform for remote customers—P to a plurality of I, I to a plurality of I, (3) means for face-to-face collaboration for remote customer—P to I, I to P, (4) means for face-to-face social collaboration for remote customers—P to a plurality of I, I to a plurality of I.

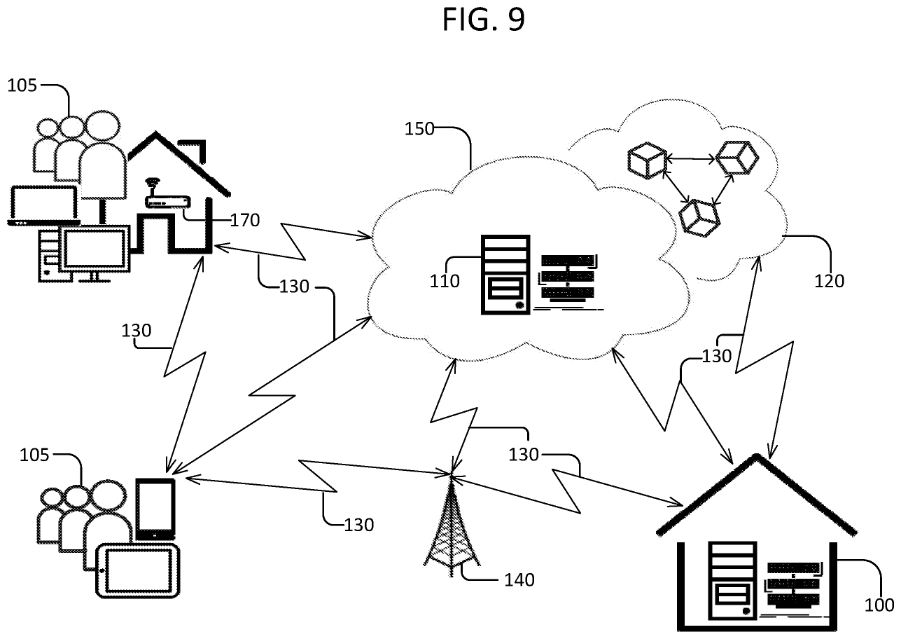

The present invention is preferably implemented as software running on a local centralized computing system as item 100, and/or in combination with remote centralized computing system as item 110, comprising communication with decentralized computing system as item 120, shown in FIG. 9, attached to digital networks as item 130, and local area networks as item 170. Preferred networks for implementing the present invention are the Internet World Wide Web as item 150, and cellular networks as item 140, which are accessible by a significant percentage of the world's population of remote customers as item 105.

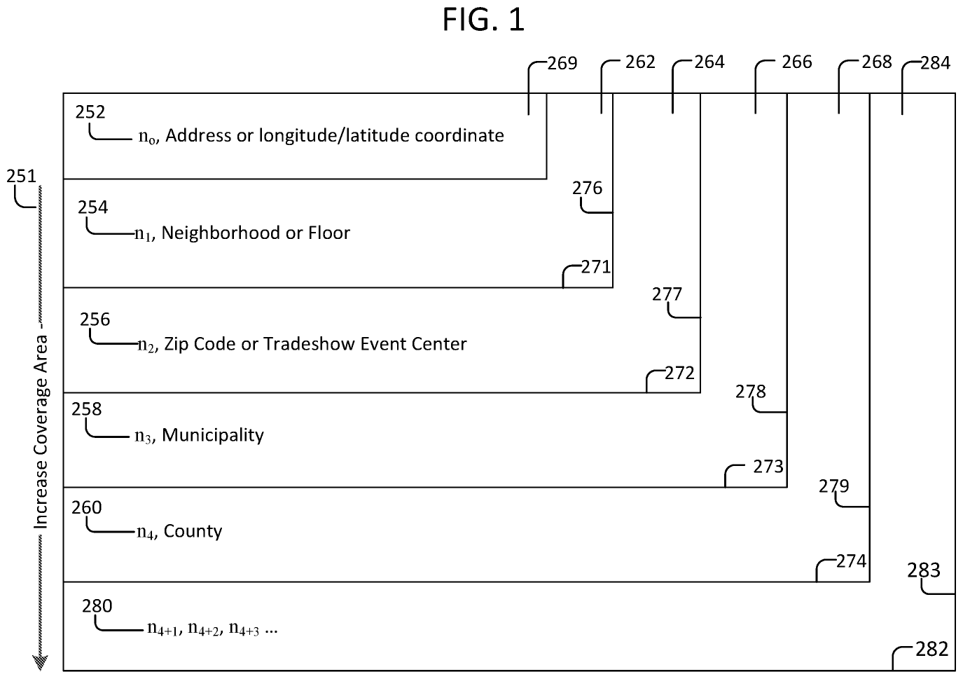

A catalog “location” is illustrated in FIG. 1 for example an open marketplace yard sale event and commercial network trade show event, where “n” as locations, comprising dataset (e.g. n₁, n₂, n₃, n₄, . . . ) for incremental distances from “nₒ” as item 251, yard sale “address” or trade show “longitude/latitude coordinate” as item 252, for event origin as item 269, and not exclusive n₁, yard sale “neighborhood” or trade show “floor” as item 254, describes increased coverage area (distance: item 276 multiply item 271) as item 262, and not exclusive n₂, yard sale “zip code” or “trade show event center” as item 256, describes increased coverage area (distance: item 277 multiply item 272) as item 264, and not exclusive n₃, yard sale or trade show “municipality” as item 258, describes increase coverage area (distance: item 278 multiplied item 273) as item 266, and not exclusive n₄, yard sale or trade show “county” as item 260, describes increase coverage area (distance: item 279 multiply item 274) as item 268, and not exclusive of a plurality of yard sale or trade show incremental datasets as item 280, describes incremental increase coverage areas (distances: item 282 multiply item 283) as item 284, extended to the utmost limits.

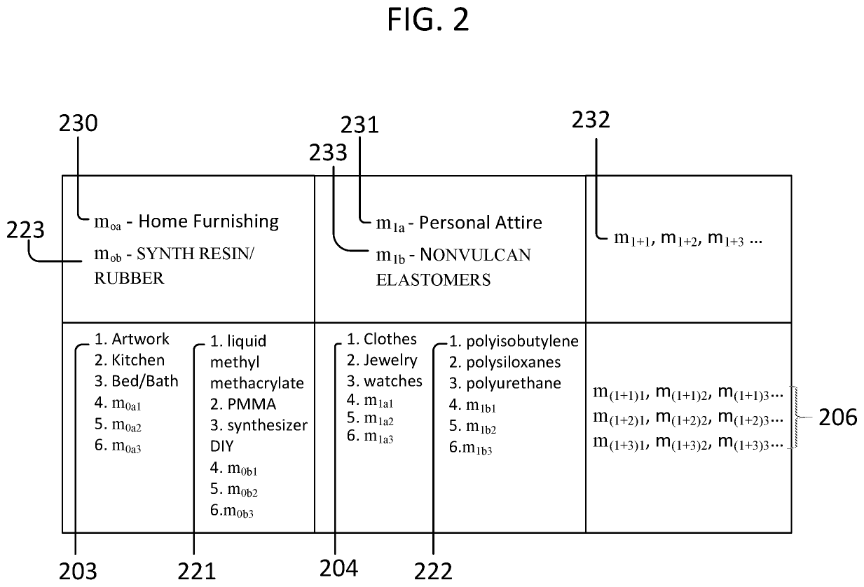

A catalog “articles” is illustrated in FIG. 2 for example an open marketplace yard sale event or commercial network for plastics industry conference event, comprising “m” for catalogs, where “mₒₐ” for yard sale “home furnishings” as item 230 or “m_{ob}” for plastics industry conference “Synth resin/rubber” as item 223, comprising dataset 1-6 (e.g., non-proprietary: 1—artwork, 2—kitchen, 3—bed/bath . . . ) as item 203, or dataset 1-6 (e.g., proprietary: 1—liquid methyl methacrylate, 2—PMMA, 3—synthesizer DIY . . . ) as item 221 respectively, and not exclusive of catalog “m₁ₐ” for yard sale “personal attire” as item 231 or “m_{1b}” for plastics industry conference “nonvulcan Elastomers” as item 233, comprising dataset 1-6 (e.g., non-proprietary: 1—clothes, 2—jewelry, 3—watches . . . ) as item 204, or 1-6 (e.g., proprietary: 1—polyisobutylene, 2—polysiloxanes, 3 polyurethane . . . ) as item 222 respectively, and not exclusive of a plurality of catalogs (e.g. mₗ₊₁, mₗ₊₂, mₗ₊₃ . . . ) as item 232, comprising a plurality of proprietary or non-proprietary datasets as item 206, extended to the utmost limits as described above.

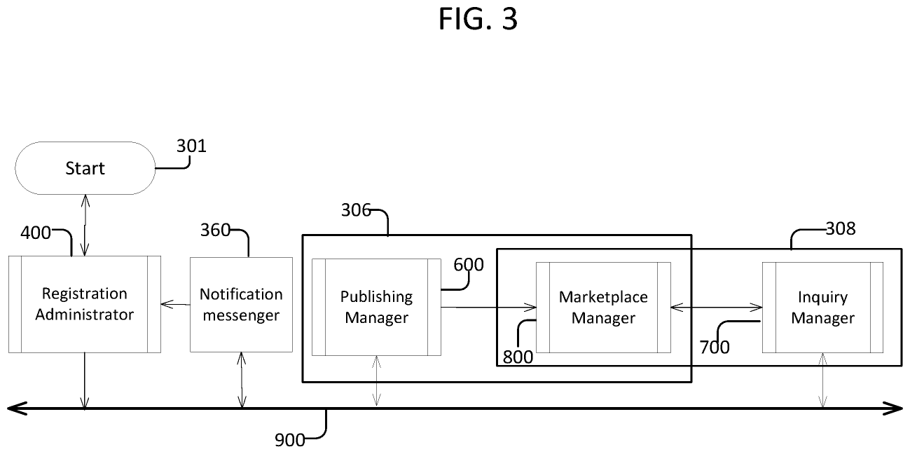

FIG. 3 illustrates a high level block diagram presented as performed on the inventive eMarketplace computing system. As shown, a customer's incoming connection is received as item 301, and processed by registration administrator, as illustrated method 400, where customer is routed according to the intent to publish or query across the systems eMarketplace backbone as item 900.

From the systems eMarketplace backbone as item 900, publisher customer participates in a publishing process as item 306, by creating webpage and catalog information, as illustrated method 600, where then publish manager releases the information for publication, and marketplace manager presents the information as an e-Marketplace publication available for query, as illustrated method 800.

From the systems eMarketplace backbone as item 900, inquiry customer participates in a query process as item 308, by creating and updating inquiry customer catalogs that best represents publications of interest by methods of inquiry manager, as illustrated method 700, where then marketplace manager enables inquiry manager to query e-Marketplace publication, as illustrated method 800.

Furthermore, because most inquiry customers are available for periodic searches and are not, in general, accessing the networks for the most recent data and publications on a continual basis, the eMarketplace system constantly monitors complementary dataset interactions where notification messenger as item 360, notifies customers of common interests through preference established by registration administrator, as illustrated method 400. Notification messages preferably contain relevant information that encourages further social interaction across the eMarketplace system, making this a convenient mechanism for keeping customers informed of new or updated publications.

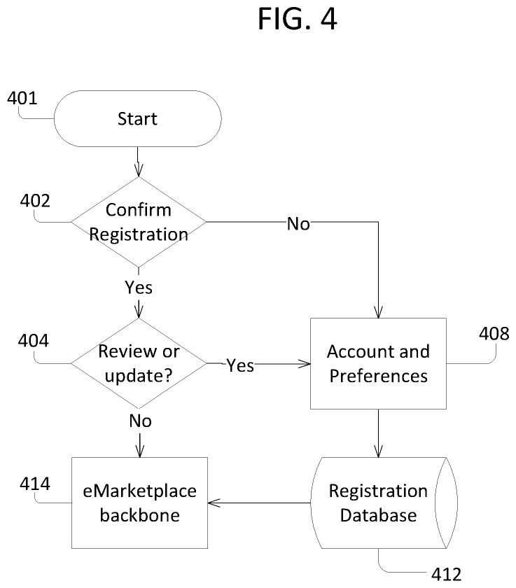

FIG. 4 illustrates in detail the procedure of a registration administrator accomplished by registration administrator 400, shown in FIG. 3. Functions of registration administrator, comprising registering, updating, processing information and acts in the interest of the customer across the eMarketplace network and platform. An application of a eMarketplace registration administrator is presented as performed on the inventive eMarketplace computing system.

As shown, an incoming transmission connection is made to the eMarketplace system at step 401, where registration administrator confirms no customer registration, determined at step 402, customer is induced to create an inquiry or publisher account not exclusive of account preferences at step 408, where registration database stores customer account and preference information at step 412, and then coordinates further action in accordance to the eMarketplace account via systems backbone at step 414.

When registration manager confirms registration, determined at step 402, customers may review and update account and preference information, determined at step 404, where information is reviewed or update at step 408, and registration database stores updates at step 412, and proceed for further actions in accordance to the account registration via systems eMarketplace backbone at step 414.

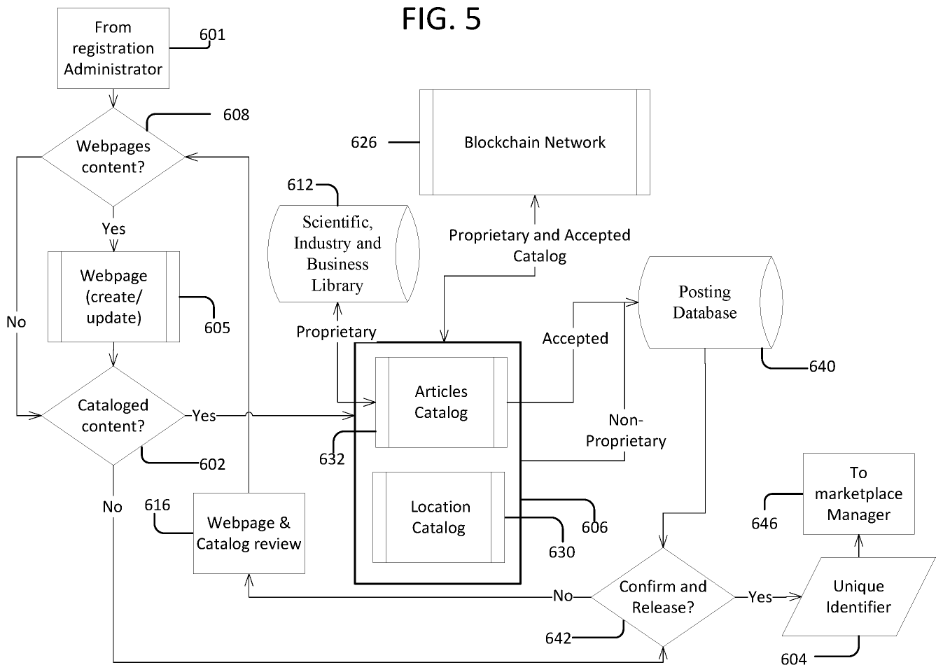

FIG. 5 illustrates in detail the procedure of a publish manager as accomplished by publish manager 600, shown in FIG. 3. Functions of publish manager, comprising primarily storing and updating publisher customer webpages and catalogs for eMarketplace publication. An application of a publish manager is presented of a marketplace event performed on the inventive eMarketplace computing system.

From registration administrator at step 601, publish manager recognizes incomplete webpage content requirements, determined at step 608, publisher customer is induced to creates or update webpages at step 605, and when publish manager recognizes incomplete catalog content requirements, determined at step 602, publisher customer is induced to create or update catalogs as item 606, comprising aforementioned “location” catalog as item 630, shown in FIG. 1, and aforementioned “articles” catalog as item 632, shown in FIG. 2.

Where publisher customer enters proprietary catalog information (e.g. aforementioned “articles” catalog Synth resin/rubber, comprising dataset: liquid methyl methacrylate, PMMA, synthesizer DIY), publish manager routes a sub-process that references scholarly journals and professional articles, e.g., scientific, industry and business database libraries, for equivalent and corresponding definitions as illustrated method 612, where then publisher customer accepts equivalent and corresponding definitions as catalog datasets as illustrated sub-method 632, where then decentralized blockchain network stores proprietary and accepted catalogs, as illustrated method 626, and posting database saves accepted catalogs, non-proprietary catalogs, and corresponding webpages at step 640, where then publish manager confirms webpage and catalog requirements and induces publisher customer to release posting database content as an eMarketplace publication, at step 642, or where publish manager recognizes incomplete requirements, publisher customer is induced to review webpage and catalog information at step 616, where updates follow a similar process as described above.

Upon confirmation of webpage and catalog requirements, publisher customer is induced to release posting database information for publication, determined at step 642, where system creates an single unique identifier for referencing eMarketplace publication at step 604, where then marketplace manager recognizes unique identifier and posting database information for eMarketplace publication at step 646, and any sequential update follow a similar process and replaces relevant content described above.

Additionally, in various embodiments of the present invention where decentralized storage technology allows query and retrieval confidentiality, blockchain storage networks, as illustrated method 626, replace centralized databases for primarily storing proprietary and sensitive catalog information as item 606, where creating, updating, and release for publication follows similar processes as described above.

Furthermore, because publisher customer accepts equivalent and corresponding definitions as additive catalogs at step 632, proprietary information is not searchable data exposed on the eMarketplace network and system, while blockchain technology provides immutable security for proprietary and sensitive information that remains accessible only to those who obtain the cryptographic “key.”

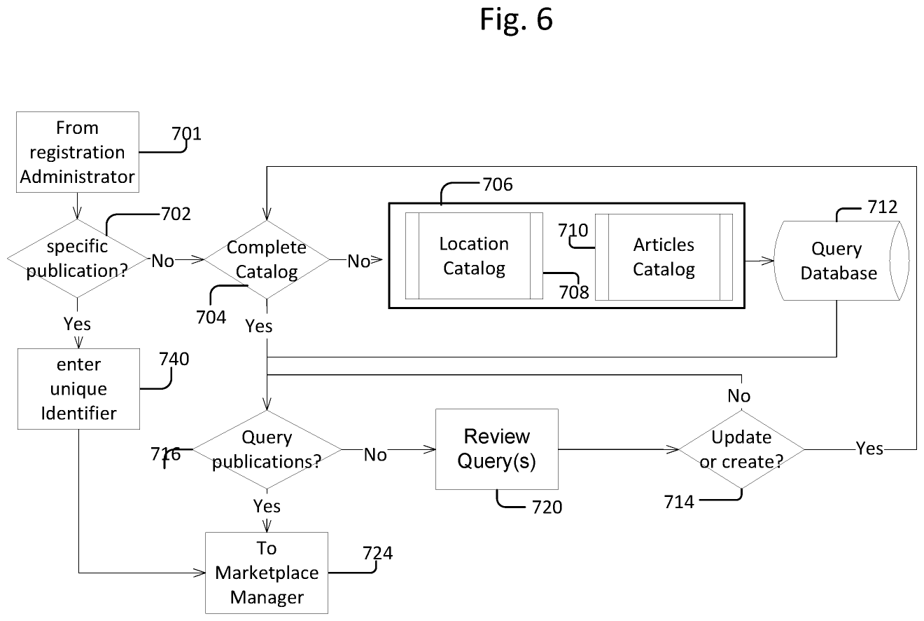

FIG. 6 illustrates in detail a procedure of inquiry manager as accomplished by inquiry manager 700, shown in FIG. 3. Functions of inquiry manager, comprising primarily storing and updating inquiry customer's catalogs. An application of an inquiry manager is presented of a marketplace event performed on the inventive e-Marketplace computing system.

From registration administrator at step 701, where inquiry customer query's a specific eMarketplace publication at step 702, inquiry manager induces inquiry customer to enter publication's aforementioned unique identifier at step 740, where query proceeds via marketplace manager at step 724, or if customer chooses not to inquire of a specific eMarketplace publication at step 702, and inquiry manager recognizes incomplete catalog query requirements, determined at step 704, customer is induced to create at least one inquiry catalogs as item 706, not exclusive of aforementioned “location” catalog at step 708, as illustrated FIG. 1, and/or aforementioned “articles” catalog at step 710, as illustrated FIG. 2, where query database stores inquiry catalogs at step 712.

When inquiry manager recognizes at least one aforementioned stored inquiry catalog, determined at step 704, inquiry customer is induced to query eMarketplace publications at step 716, via marketplace manager at step 724, or review stored inquiry catalogs at step 720, to update or create additional inquiry catalogs at step 714.

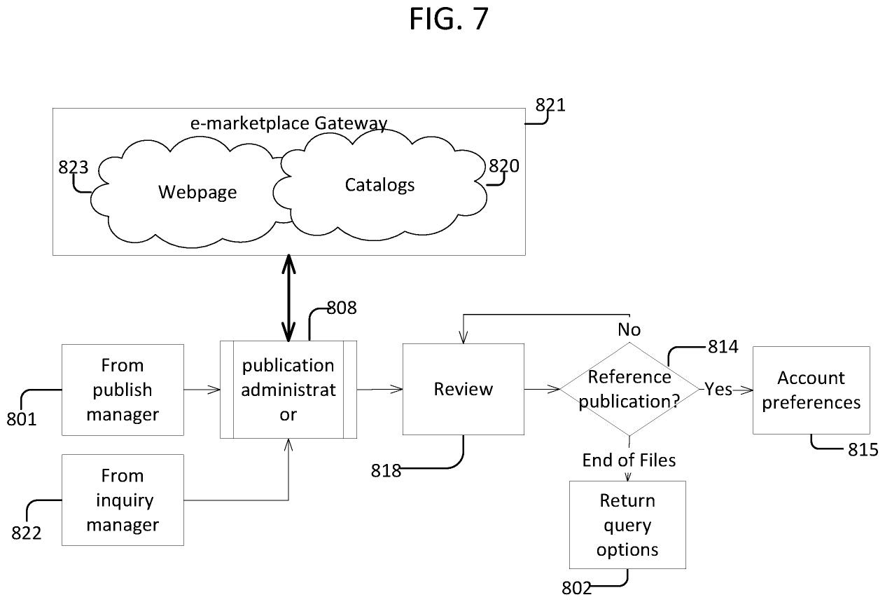

FIG. 7 illustrates in detail the procedure of marketplace manager accomplished by marketplace manager 800, shown in FIG. 3. Functions of marketplace manager, comprising navigating customers across the eMarketplace computing platform, enables store, query, and present eMarketplace publications. An application of a marketplace manager is presented as performed on the inventive eMarketplace computing system.

From aforementioned publish manager at step 801, publication administrator recognizes publish manager to release aforementioned posting database content, as illustrated method 808, where then e-marketplace gateway as item 821, stores publication catalogs separate from associated webpages as item 820, and item 823 respectively, and generates an digital-relationship for published webpages and associated catalogs.

From aforementioned inquiry manager at step 822, publication administrator enables inquiry manager to query catalogs at step 808, for complementary catalog interaction as illustrated method 820, of e-marketplace gateway at step 821, where publication administrator recognizes associated webpages from complementary catalogs, as illustrated method 823, and presents associated webpages available for review at step 818, and publication administrator enables inquiry manager to maneuver through and reference eMarketplace publications of their own liking at step 814, where aforementioned registration database stores publication's aforementioned unique identifier for aforementioned account preference for future ease to access specific eMarketplace publications at step 815. When publication review ends, customer is provided further eMarketplace query options at step 802.

One skilled in the art to which the present invention pertains will recognize that various components of the eMarketplace system can communicate between themselves in a variety of ways. In a preferred embodiment, managers, administrators, and notification messenger communicate by adding, marking, and updating records in various data storage applications. Each of these components periodically checks at least one of the various applications to see if anything relevant to their respective functions has changed and takes action accordingly. However, components could send direct messages between themselves or call each other by means of program subroutines to signal important events that would require one or other components to update its state.

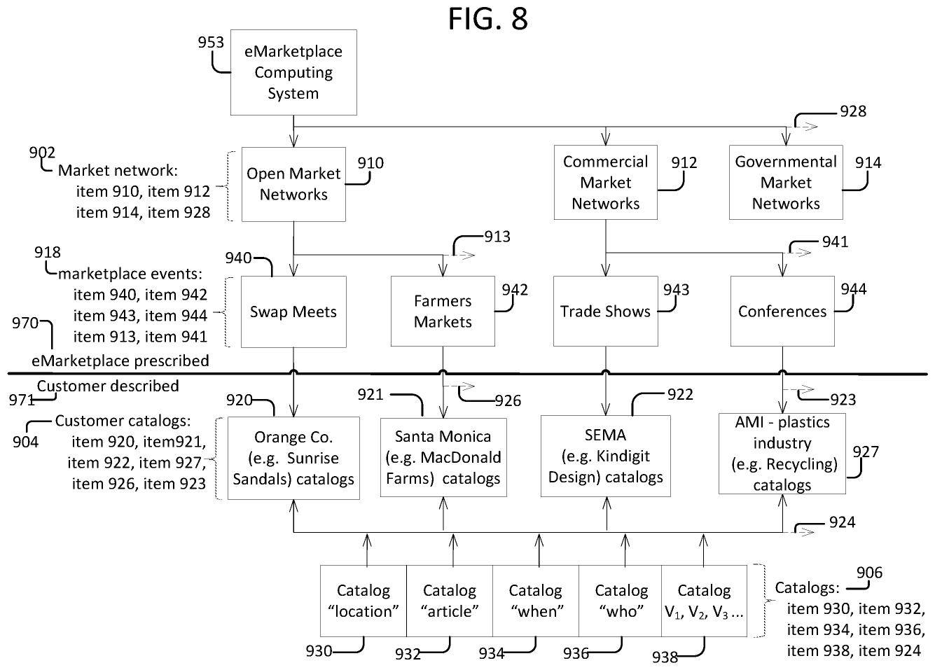

Various eMarketplace computing system embodiments that follow a similar publications and query format is illustrated in FIG. 8, as item 953, comprising eMarketplace networks for open markets as item 910, for example swap meets as item 940, and farmer market as item 942, examples comprising Orange County Swap Meet, for example “Sunrise Sandals” catalogs as item 920, and Santa Monica Farmers Market for example “MacDonald Farms” produce catalogs as item 921 respectively, and a plurality of open markets as item 913, and customer catalogs as item 926, extended to the utmost limits.

Similarly, eMarketplace networks for commercial markets follow a similar framework as item 912, for example Trade Shows as item 943, and Conference events as item 944, examples comprising SEMA Auto Show, for example “Kindigit Design” catalogs as item 922, and AMI plastics industry for example recycling catalogs as item 927 respectively, and a plurality of commercial market events as item 941, and customer catalogs as item 923, extended to the utmost limits.

Additionally, Governmental market networks as item 914 and a plurality of additional market networks as item 928, follow the similar market framework as item 902, comprising a plurality of marketplace events as item 918, and customer catalogs as item 904, extended to the utmost limits as described above. Additionally, customer catalogs as item 906, describes a plurality of catalogs “V₁, V₂, V₃ . . . ” as item 938, extends to the utmost limits as item 924.

One skilled in the art to which the present invention pertains will further recognize that a variety of different customer publisher and inquiry catalog formats may be implemented using the basic techniques described above. The technique provides standard applications for independent and organized catalog formats by the adding or removing of catalogs to optimize the exchange between customers. Furthermore, because each customer chooses catalogs to substantiate their opportunity, the adding or removing of catalog may not be the same however the system may recommend customer interactions based on relevant datasets and or system computations.

In general, and for a wide variety of applications, the eMarketplace system shown in FIG. 8, prescribes the eMarketplace opportunity (i.e., above the thick line) as item 970, and provides a wide variety of customer described catalog formats that allows personalized detail for specific events (i.e., below the thick line) as item 971, comprising a standard order of independent and organized event catalogs that best represents customer interests.

One skilled in the art to which the present invention pertains will also recognize that a variety of different eMarketplace opportunities may be implemented in addition to those described above. The present invention provides for optimal exchange between customers of common interests while protecting proprietary data and information, and ultimately for face-to-face collaboration. Furthermore, because many marketplace events are unique and support a diverse audience, the eMarketplace allows the systems format to be presented differently, however does provide event catalog characteristics most interested by the publisher and inquiry customers.

One skilled in the art will also recognize that the present invention can employ a plurality of network platforms that provides features incorporated within context of the eMarketplace system described above. Features allow for interaction across these platforms that provide a seemingly transparent exchange of information using relevant communication technology and transmission applications.

A description of the present invention as well as a preferred embodiment of the present invention has been set forth above. Those skilled in the art to which the present invention pertains will recognize and be able to practice additional variations in the methods and system described which fall within the teachings of this invention. Although the present invention has been described in considerable detail with reference to certain preferred versions thereof, other versions are possible. Therefore, the spirit and scope of the appended claims should not be limited to the description of the preferred versions contained therein.

The reader's attention is directed to all papers and documents which are filed concurrently with this specification and which are open to public inspection, and the contents of all such papers and documents are incorporated herein by reference. All features disclosed in this specification (including any accompanying claims, abstract, and drawings) may be replaced by alternative features serving the same, equivalent or similar purpose, unless expressly stated otherwise. Unless expressly stated otherwise, each feature disclosed is one example only of a generic series of equivalent or similar features. The applicant intends to encompass any structure presently existing or developed in the future that performs the same process and function.

What is claimed is:

1. In an electronic communication platform between a computing system and a plurality of network-based remote customers, an internet information transmission and processing system for time-bounded marketplace events, including means for publishing and querying electronic marketplace event catalogs, social networking across said platform before said marketplace events, and induces said remote customers collaboration during and after said marketplace events, said system comprising:
datasets, said an dataset comprising said remote customer said cataloged data and information;
digital storage media connected in communication with said computing system for primarily storing said catalogs and webpages;
an e-marketplace gateway connected in communication with said computing system and said digital storage media for primarily storing said catalogs and said webpages, including means for creating digital-relationship for associated said webpages and said catalogs;
a publish manager implemented in said system and in communication with said digital storage media, including means for primarily creating, securing and publishing remote publisher customer said catalogs and said webpages;
a inquiry manager implemented in said system and in communication with said digital storage media, including means for primarily creating remote inquiry customer said catalogs and querying said eMarketplace publications;
a marketplace manager implemented in said computing system and in communication with said managers and said e-marketplace gateway, enabling means for said e-marketplace gateway store and query said publications;
a publication administrator implemented in said system and in communication with said managers, including means for navigating said remote customers across said e-marketplace gateway;
a registration administrator implemented in said system and in communication with said digital storage media and said managers for primarily creating and updating said remote customer records;
a notification messenger implemented in said system for notifying said remote customers across said network and platform;

2. A method of claim 1 wherein said registration administrator connects said remote customers transmission across said network and platform, said publish manager induces said publisher customer create said catalogs and said webpages, and said digital-storage media stores said catalogs and said webpages, where then said publication administrator induces said publish manager release said catalogs and said webpages for said eMarketplace publication, where then said marketplace manager enables said e-marketplace gateway create said digital-relationship and digital storage media stores separate said catalogs and said webpages for secure said eMarketplace publication available for query, said inquiry manager induces said inquiry customer create said catalogs for querying complementary said e-marketplace catalogs and present said associated webpages for review, where then said system induces social interaction for said remote customers across said network and platform and ultimately face-to-face marketplace event collaboration;

3. A method of claim 1 enabling said notification messenger notify said remote customers of new or updated complementary said catalogs, where then said system induces said remote customers interaction across said network and platform and ultimately face-to-face marketplace event collaboration;

4. A system of claim 1 enabling customers communication being descriptive of publisher P, inquiry I, comprising:
means for interaction across said network and said platform with said remote customer—P to I, I to P;
means for social interaction across said network and said platform with said remote customers—P to a plurality of I, I to a plurality of I;
means for face-to-face collaboration with said remote customer—P to I, I to P;
means for face-to-face social collaboration with said remote customers—P to a plurality of I, I to a plurality of I.
